(19) United States
(12) Patent Application Publication
(10) Pub. No.: US 2026/0044264 A1
(43) Pub. Date: Feb. 12, 2026

(54) WRITING OF MULTI-LEVEL CELL DATA

(71) Applicant: Microchip Technology Incorporated, Chandler, AZ (US)

(72) Inventors: Nian Niles YANG, Mountain View, CA (US); Pitamber SHUKLA, San Jose, CA (US); Chris NORRIE, Castro Valley, CA (US)

(21) Appl. No.: 18/885,555

(22) Filed: Sep. 13, 2024

Related U.S. Application Data
(60) Provisional application No. 63/680,607, filed on Aug. 7, 2024.

(51) Int. Cl. G06F 3/06

(52) U.S. Cl. CPC G06F 3/0619; G06F 3/0659; G06F 3/0679

(57) ABSTRACT

In some implementations, a storage device may receive data for storage with a first cell order on a storage medium. The storage device may encode the data with a first encoding to generate single-encoded data. The storage device may encode the single-encoded data with a second encoding to generated double-encoded data. The storage device may write the double-encoded data, having a second cell order that is lower than the first cell order, to one or more first blocks of the storage medium. The storage device may read the double-encoded data at the storage medium. The storage device may perform decoding, associated with the second encoding, on the double-encoded data at the storage medium to generate error-corrected single-encoded data. The storage device may write the error-corrected single-encoded data, having the first cell order, to one or more second blocks of the storage medium.

### CROSS-REFERENCE TO RELATED APPLICATION

This Patent Application claims priority to Provisional Patent Application No. 63/680,607, filed on August 7, 2024, and entitled “WRITING OF MULTI-LEVEL CELL DATA.” The disclosure of the prior Provisional Patent Application is considered part of and is incorporated by reference into this Patent Application.

### FIELD

The present disclosure generally relates to a storage device that is capable of performing operations using at least a first order and a second order. For example, the storage device may be capable of performing read/write operations using two or more of single-level cell (SLC), multi-level cell (MLC), triple-level cell (TLC), quad-level cell (QLC), or penta-level cell (PLC), among other examples. In some examples, the write operation may include writing host data on a first set of lower cell order blocks and then folding (e.g., copying) the data from the first set of lower order blocks to a higher cell order block for storage of the host data with improved efficiency.

### BACKGROUND

A storage device may include one or more storage media that may store and retain data without external power supply. One example of a storage device is a negative-and (NAND) flash memory device where the one or more storage media include one or more NANDs. The storage device may include non-volatile storage (e.g., NANDs) and volatile storage (e.g., double data rate (DDR) storage).

The storage device may store data as bits within the storage device (e.g., within the non-volatile storage). For example, the storage device may include transistors that store bit values. In some aspects, the storage device may include cells (e.g., associated with one or more transistors) that store bit values. To write bits to the cells, the storage device may apply a write or program voltage to transistors such that a read operation associated with the transistors produces a read voltage associated with the bits. Cells may be single-level cells (SLC) associated with a first order or a multi-level cell (MLC) associated with an order that is at least two. For example, an MLC may include a third order cell (e.g., triple-level cell (TLC)), a fourth order cell (e.g., quad-level cell (QLC)), or a fifth order cell (e.g., penta-level cell (PLC)), among other examples.

### BRIEF DESCRIPTION OF THE DRAWINGS

FIG. 1 is a diagram of an example of writing of multi-level cell data described herein.

FIG. 2 is a diagram of an example of writing of multi-level cell data described herein.

FIG. 3 is a diagram of example components of one or more devices of FIGS. 1-2.

FIG. 4 is a flowchart of an example process associated with adjusted programming associated with prior read errors described herein.

### DETAILED DESCRIPTION

The following detailed description of example implementations refers to the accompanying drawings. The same reference numbers in different drawings may identify the same or similar elements.

A non-volatile memory device (e.g., a negative-and (NAND) memory device, also referred to as storage media) may store data based at least in part on write operations initiated by a controller. The controller may include one or more of an application specific integrated circuit (ASIC) or firmware. In some examples, the storage media and the controller may be included in a storage device.

Writing using a multi-level cell (MLC) (e.g., a triple-level cell (TLC), a quad-level cell (QLC), or a penta-level cell (PLC), among other examples) may result in an increased likelihood of errors. To mitigate the increased likelihood of errors and to assist in error correction, data may be written as lower order (e.g., a single-level cell (SLC)) data on one or more first blocks of a storage medium and the data may be copied (e.g., folded) from the one or more first blocks to one or more second blocks as MLC data. When copying from the one or more first blocks to the one or more second blocks, any erroneous bits from the lower order data will be copied to the MLC data, which may cause uncorrectable errors in the MLC data. The uncorrectable errors may cause an associated computing device to consume computing resources to obtain and re-write the data or recover from an error.

To avoid the uncorrectable errors propagating from the one or more first blocks (e.g., SLC blocks) to the one or more second blocks associated with MLC data, some storage devices avoid on-chip copying of the data and instead resend the data to an associated storage medium when performing the writing on the one or more second blocks. However, this may consume resources of the storage device or cause traffic that may increase latency for other operations of the storage device.

In some aspects described herein, a storage device may use on-chip copying of the data from one or more first blocks associated with a lower cell order to one or more second blocks associated with a higher cell order. To reduce errors of the on-chip copying, data may be encoded with additional decoding when written to the one or more first blocks. When copying the data from the one or more first blocks, the storage medium performs decoding on the copied data to correct any errors of the data on the one or more first blocks. The data is then written to the one or more second blocks with a reduced quantity of encoding layers (e.g., from two layers to one layer). In this way, the data copied to the one or more second blocks may have a reduced likelihood of error copying, which may conserve computing resources associated with error recovery, re-obtaining the data from another source and re-writing to the storage medium, or sending the data to the storage medium twice (e.g., first for the one or more first blocks and second for the one or more second blocks).

In some aspects, the data may be encoded with a first error correction code, such as low-density parity check (LDPC) encoding or other linear error correcting code, before being sent to the storage medium when being stored as data with any cell order. In some aspects, the data may be encoded again (e.g., double-encoded) using a second error correction code, such as a Bose–Chaudhuri–Hocquenghem (BCH) or other cyclic error-correcting coding, before being sent as lower cell-ordered data for storage and copying for writing as higher cell-ordered data.

In some aspects, additional parity for the second encoding (e.g., BCH encoding) may be associated with parity bits inserted to spare bits of the storage medium (e.g., column redundancy bits). For example, the second encoding may use an extra byte after a first codeword associated with the first encoding (e.g., a data frame). The extra byte may be inserted into extra bytes of bits that are associated with redundancy columns. For example, in some storage media, about 1% of bitline direction columns may be dedicated for column redundancy. For a 4KB data frame, this is about 41 Bytes. These extra bytes may be used for the second encoding (e.g., BCH coding).

In some aspects, the spare column may be associated with repairs to blocks with bad columns (e.g., bitlines). In some aspects, the storage medium may record blocks that are to be repaired (e.g., with errors to be recovered) so as to avoid using the recorded blocks to store bits for the second encoding. However, for blocks that do not use bits (from the column redundancy) for repairs, the associated bits may be used for extra parity bits associated with the second encoding of the lower cell-order data. For decoding (e.g., to decode the second encoding) the data that has been encoded by the first encoding and the second encoding (e.g., double-encoded data), the storage medium may use an internal decoder (e.g., a BCH decoder) between page buffers for the inter-buffer data transferring when enabled.

In some aspects, the storage device may perform the second decoding using an application specific integrated circuit (ASIC) error correction code engine on a controller of the storage device. The storage medium may decode the data using a decoding engine (e.g., BCH decoding engine) built into a storage medium page buffer transferring mechanism between internal latches.

In an example, the storage device may “double-up” an ASIC error correction code engine with a strong LDPC encoder, followed by a BCH engine. In some aspects, all data traffic (e.g., SLC, QLC, PLC) may be encoded and decoded with a first encoding (e.g., LDPC encoding). Lower cell-order data (e.g., SLC data) may undergo additional encoding (e.g., BCH encoding). The lower cell-order data, inside the storage medium, is decoded by a decoder (e.g., BCH decoder) during an on-chip-copy to the higher cell-order data so that the data folded to one or more blocks associated with the higher cell-order data is clean to begin with, and is still encoded by the first encoding (e.g., LDPC decoding).

The lower cell-order data, if to be read by the system, will go through decoding via a first decoding associated with the second encoding (e.g., BCH decoding) and a second decoding associated with the first encoding (e.g., LDPC decoding). For a data read from the higher cell-order data after copying (e.g., SLC-to-QLC folding), the data can be read with the second decoding and not the first decoding because the first decoding has been completed during the on-chip-copy..

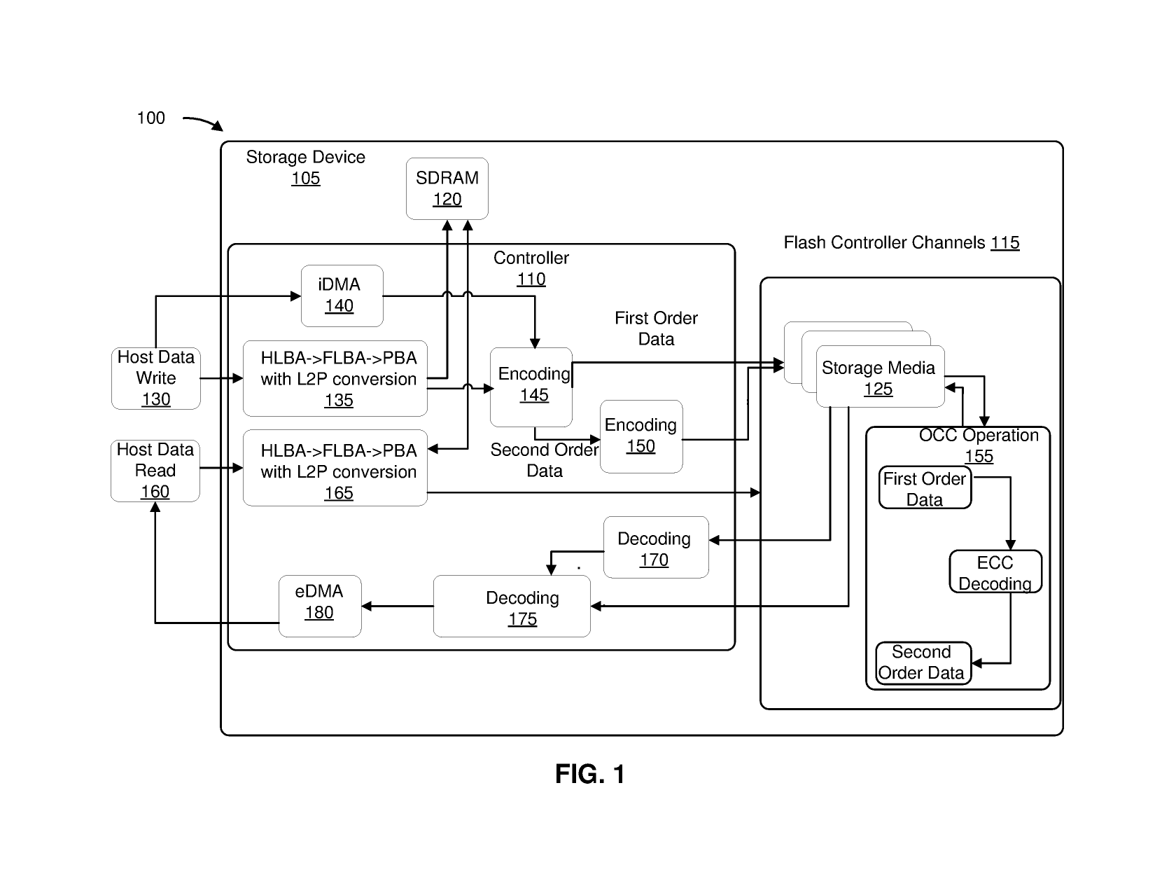

FIG. 1 is a diagram of an example 100 of a device performing writing of multi-level cell data described herein. Example 100 describes components and operations associated with a storage device 105. In some aspects, the storage device 105 may include a solid state drive (SSD) or another type of storage device. As shown in FIG. 1, the storage device 105 may include a controller 110, flash controller channels 115 that include storage media 125, and synchronous dynamic random access memory (SDRAM) 120. In some aspects, the SDRAM 120 may provide a relatively small amount of storage (e.g., gigabytes of storage) to be accessed by the controller 110 to operate the storage device 105. In some aspects, the flash controller channels 115 may be used to store a relatively large amount of data (relative to the SDRAM 120, e.g., terabytes of storage). The storage device 105 may store host data on the storage media 125.

As shown by reference number 130, the storage device 105 may receive host data for a write operation. For example, a host (e.g., a host device not shown) may provide the host data with a command to write to a storage medium. As shown by reference number 140, the storage device 105 may process the host data via an ingress direct memory access (iDMA) operation in preparation for storage to the storage media 125.

The storage device 105 may identify a host logical block address (HLBA) associated with the host data by which the host may reference the host data in a future read operation. As shown by reference number 135, the storage device may convert the HLBA to a flash logical block address (FLBA) or other local logical block address, and then may link the FLBA to a physical block address (PBA) using logical to physical (L2P) conversion. In this way, the host may send a static address associated with the host data, the storage device 105 may link the address known to the host to an address known to the storage device (the FLBA), and may link the address known to the storage device to a physical address of the host data within the storage medium. The storage device 105 may store the links between the HLBA, the FLBA, and the PBA in the SDRAM 120. In some aspects, the host data may be moved within a storage medium of the storage media 125 or between a first storage medium and a second storage medium of the storage media 125, which the storage device 105 may note in the link between the FLBA and the physical location. In this way, the HLBA does not need to be updated when the host data is moved to a new PBA.

As shown by reference number 145, the storage device 105 may perform encoding (e.g., error correction code encoding) on the host data. For example, the controller 110 may include an error code encoder that performs the error correction code encoding. In some aspects, the error correction code encoding may include adding redundancy, parity bits, or other information that can later be used to identify errors in the host data when read from the storage medium. The encoding 145 may include a linear error correction code encoding or LDPC encoding. The storage device 105 may provide the host data (e.g., first order data, such as higher cell-order data or data not to be used for copying within the storage medium 125), after encoding, via the flash control channels 115 to write on the storage media 125.

In some aspects, such as when the storage device is providing lower cell-order data to a storage medium in anticipation of copying the lower cell-order data to another block as higher cell-order data, the storage device 105 may send the encoded data (e.g., second order data that is lower cell-order data to be copied within the storage media 125) for further encoding at reference number 150. The encoding at reference number 150 may include cyclic error-correcting encoding, BCH encoding, or other encoding scheme associated with a low likelihood of error (e.g., with an expectation that the lower cell-order data is unlikely to have many errors), among other examples. This double-encoded data may be sent to the storage media 125.

The storage media 125 (e.g., one or more storage media) may perform an on-chip copying (OCC) operation 155. As shown in FIG. 1, a storage medium (e.g. using a built-in decoder, such as a BCH encoder associated with a buffer) may read first order data, perform error correction code decoding (e.g., BCH decoding, cyclic error correction code decoding, or other encoding scheme associated with a low likelihood of error), and generate second order data. The second order data may be single-encoded data that has had errors corrected based at least in part on the error correction code decoding. The second order data may be written as second cell-order data on one or more blocks of a storage medium.

As shown by reference number 160, the storage device 105 may receive a request from a host to read data from the storage medium. For example, the host may provide a request to read the host data that was provided for writing in connection with reference number 130. As shown by reference number 165, the storage device 105 may perform HLBA to FLBA to PBA conversion. For example, the controller 110 may identify the HLBA in the request and may provide the HLBA to the SDRAM 120 to identify the FLBA or the PBA. The SDRAM may have stored the link between the HLBA to the PBA in connection with a previous write command.

Once the PBA is identified in connection with the request, the controller 110 may read the storage media 125 via the flash controller channels 115 at the PBA. For example, the controller 110 may obtain sensing results at the PBA. As shown by reference number 170, the controller 110 may perform first decoding on data read from the storage medium 125. For example, the controller 110 may perform decoding on double-encoded data that was stored as lower cell-order data (e.g., SLC data) in anticipation of being copied in the OCC operation 155. Other data that is single-encoded data may skip decoding at reference number 170.

After decoding at reference number 170, or if skipping decoding at reference number 170 based at least in part on being single-encoded data, read data may be decoded at reference number 175. Data decoded at reference number 175 may include data that was provided to the storage media 125 after encoding 145 (skipping encoding 150), data that had the encoding of reference number 150 decoded in connection with the OCC operation 155, or data that had the encoding of reference number 150 decoded in connection with reference number 170. Decoding at reference number 175 may include LDPC decoding or linear error correction code, among other examples.

As shown by reference number 180, the controller 110 may perform egress direct memory access (eDMA) to isolate the host data of the request for sending to the host. For example, an eDMA controller (e.g., eDMA engine) may perform eDMA to isolate data to be delivered to the host in association with the read request. In some aspects, the host may send multiple read requests to the storage device 105 and eDMA may be used to isolate a portion of read data that is to be provided to the host for a specific read request. In some examples, the eDMA controller may have access to a number of the flash controller channels 115. In some aspects, the flash controller channels 115 may be used in parallel so the eDMA may perform multiple commands via multiple flash controller channels 115.

The number and arrangement of components shown in FIG. 1 are provided as an example.

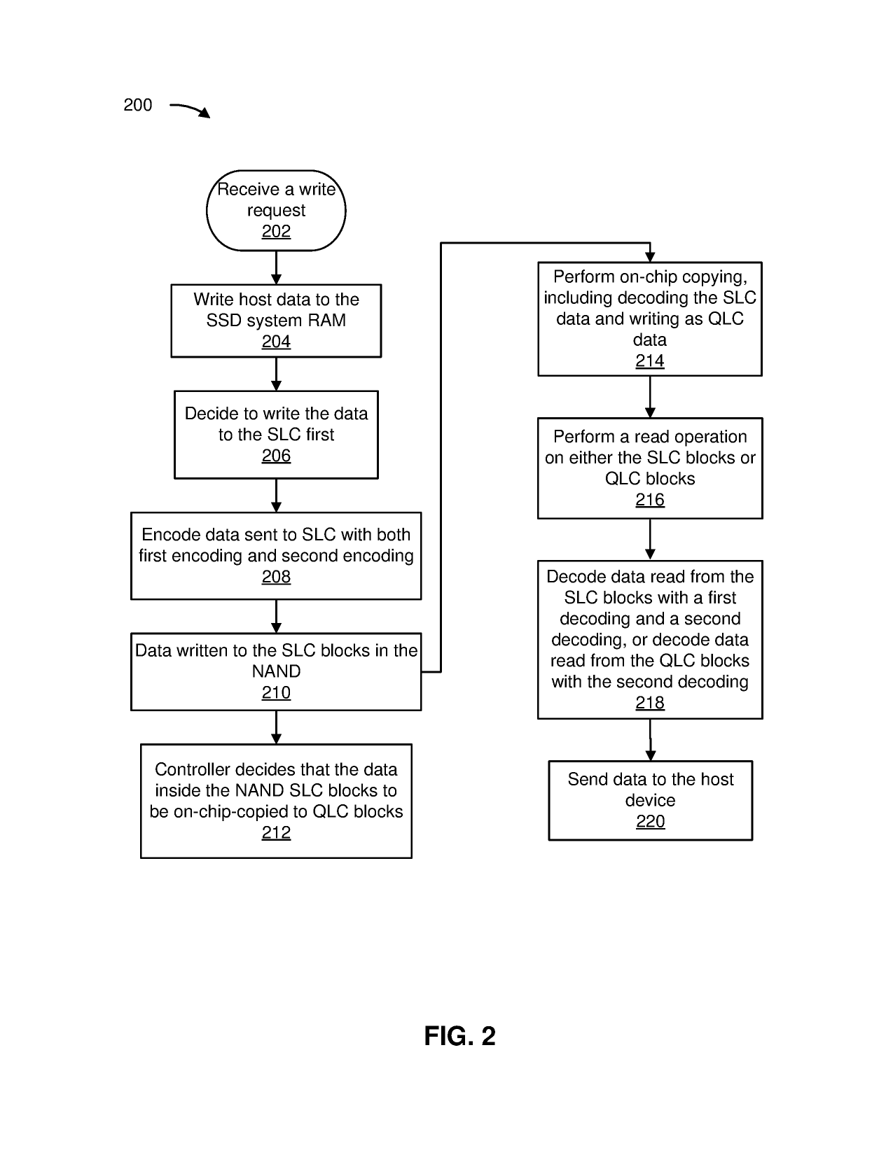

FIG. 2 is a diagram of an example 200 of writing of multi-level cell data described herein. The operations described in connection with example 200 may be performed by a storage device, or one or more components of the storage device, such as a controller or storage medium, among other examples.

As shown in FIG. 2, and by reference number 202, a storage device may receive a write request. The storage device may receive the write request from a host device, and may include host data to be written.

As shown by reference number 204, the storage device (e.g., a controller of the storage device) may write the host data to an SSD system RAM in preparation for writing to storage media.

As shown by reference number 206, the storage device (e.g., a controller of the storage device) may decide to write the data to one or more SLC blocks (or other lower cell-order block) first (e.g., before writing to an MLC block having a higher cell order).

As shown by reference number 208, the storage device (e.g., a controller of the storage device) may encode the host data for sending to the one or more SLC blocks with a first encoding (e.g., LDPC) and a second encoding (e.g., BCH). In some aspects, the second encoding may use parity bytes that match internal spare column bytes of a storage medium.

As shown by reference number 210, the storage device (e.g., a controller of the storage device) may write the data (double-encoded data) to the one or more SLC blocks of a storage medium. The one or more SLC blocks may be clean blocks that are not associated with use of spare columns for repair (e.g., with open redundancy columns).

As shown by reference number 212, the storage device (e.g., a controller of the storage device) may decide to use on-chip copying to copy the data of the one or more SLC blocks to one or more QLC blocks.

As shown by reference number 214, the storage device (e.g., a storage medium of the storage device) may perform the on-chip copying, including decoding the SLC data and writing as QLC data. The storage device may use an on-chip decoder (e.g., BCH decoder) to decode the one or more SLC blocks after reading from the SLC blocks. The storage device may read and decode multiple SLC blocks to generate data to be written to one QLC block (or other type of MLC block). For example, when copying SLC data to QLC blocks, 4 SLC blocks may be combined for writing to 1 QLC block. After reading and decoding (e.g., error correction decoding) the one or more SLC blocks, the storage device may write the data to the one or more QLC blocks.

As shown by reference number 216, the storage device may perform a read operation on either the one or more SLC blocks or one or more QLC blocks.

As shown by reference number 218, the storage device may decode data read from the one or more SLC blocks with a first decoding and a second decoding, or decode data read from the one or more QLC blocks with the second decoding. The data read from the one or more SLC blocks may still be double-encoded data, and may therefore have both decoding operation performed. The data read from the one or more QLC blocks may have already had the first decoding applied during the on-chip copying, and may therefore skip the first decoding operation.

In some aspects, the storage device (e.g., a controller of the storage device), may be aware of what block type is being read, and may perform BCH and LDPC double decoding for SLC data, or LDPC decoding (and not BCH decoding) for QLC data.

As shown by reference number 220, the storage device may send the data to the host device 220. In some aspects, the storage device may send the data to the host device after decoding and associated error correction code is performed.

The number and arrangement of components shown in FIG. 2 are provided as an example. For example, FIG. 2 illustrates a scenario where the write operation is a QCL write operation (e.g., with QLC data and QLC blocks). However, other cell orders of MLC write operations may also be used with other MCL data and MLC blocks. Additionally, or alternatively, the write operations are described in connection with SLC write operations to SLC blocks. However, other cell orders of write operations may be used, wherein a cell order used is lower than a cell order of the second order data.

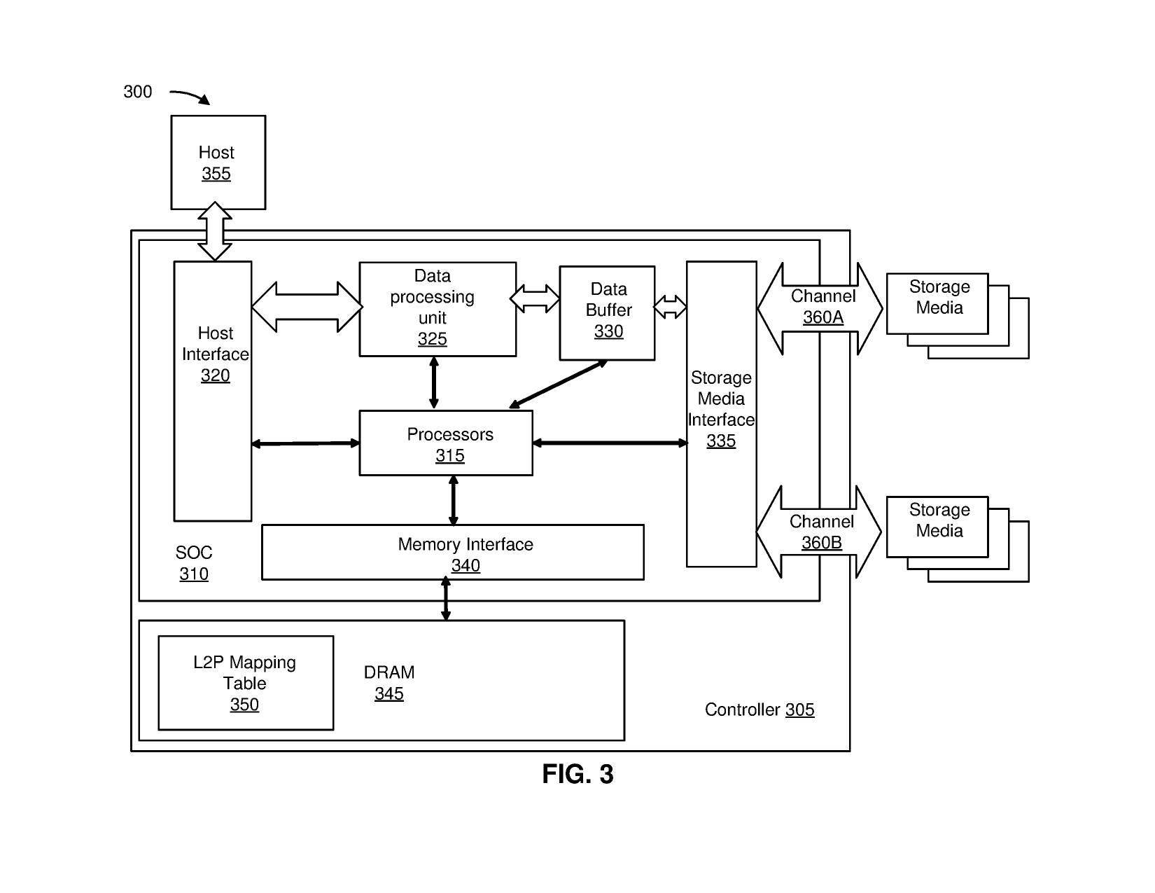

FIG. 3 is a diagram of example components of a storage device 300, which may correspond to one or more devices of FIG. 1 or FIG. 2.

As shown in FIG. 3, the storage device 300 may include a controller 305 (e.g., an SSD controller). The controller 305 may include a system on chip (SOC) 310. The SOC 310 may perform computing or processing operations for the controller 305. The SCO may include one or more processors 315 that control, command, or observe operations at one or more other components of the SOC 310. The one or more processors 315 may be communicably coupled too one or more of a host interface 320, a data processing unit 325, a data buffer 330 a storage medium interface 335, or a memory interface 340.

The controller 305 may further include DRAM 345. The DRAM 345 may locally store information that is available on demand at the controller 305 for operations of the controller 305. For example, the DRAM 345 may store an L2P mapping table 450 that maps logical locations of data and physical locations of data on connected storage media. In this way, the controller 405 may have access to mapping information for locating data on the connected storage media based at least in part on an indication associated with host data when written.

The host interface 320 may provide an interface for communicating with a host 355. For example, the host interface 320 may receive an access request or data for storage on connected storage media. In some aspects, the host interface 320 may provide data to the host after reading the data on from the connected storage media.

The storage media interface 335 may communicate via one or more channels 360 (e.g., 360A and 360B) with one or more connected storage media 365 (e.g., 365A and 365B). For example, the controller 305 may perform or initiate a read or write operation at a physical location of a storage media device 365.

The number and arrangement of components shown in FIG. 3 are provided as an example.

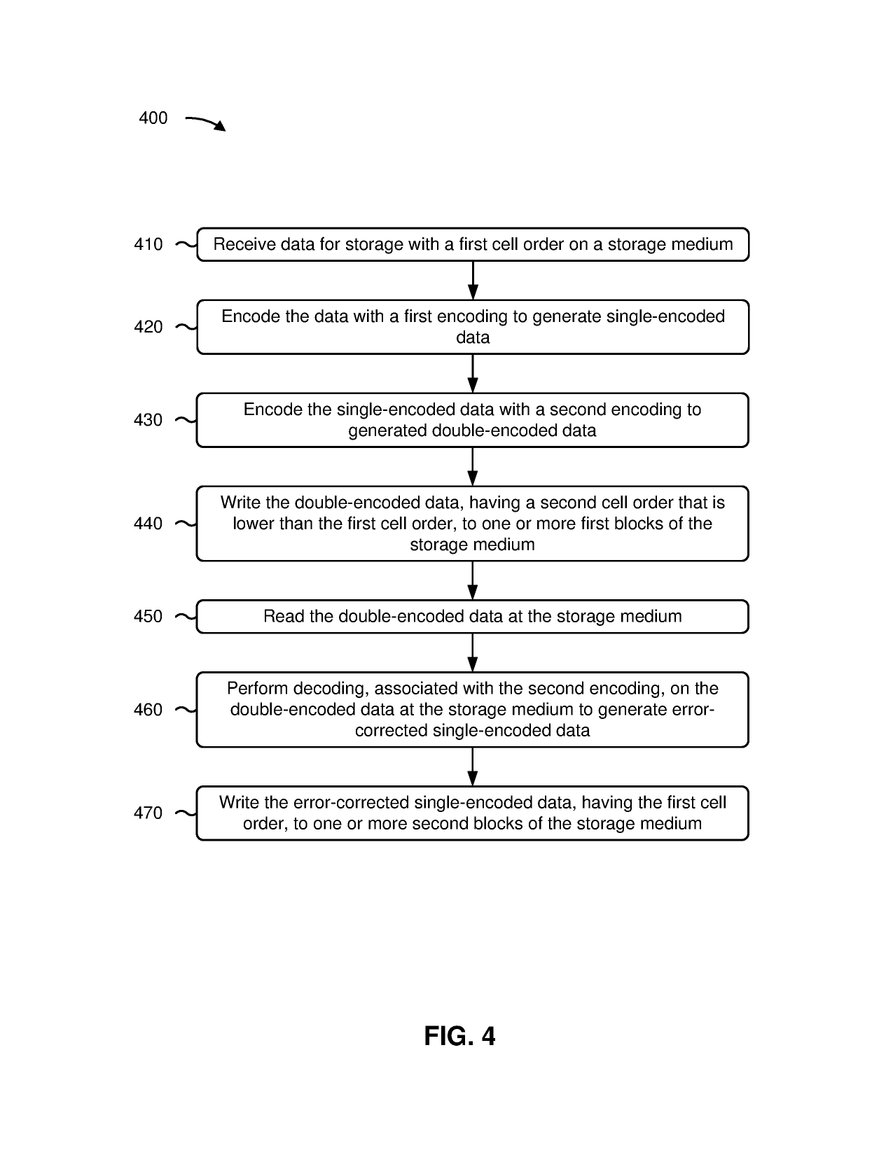

FIG. 4 is a flowchart of an example process 400 associated with writing of multi-level cell data described herein. In some implementations, one or more process blocks of FIG. 4 may be performed by a storage device (e.g., storage device 300). In some implementations, one or more process blocks of FIG. 4 may be performed by another device or a group of devices separate from or including the storage device, such as a storage medium 202 or a controller 305. Additionally, or alternatively, one or more process blocks of FIG. 4 may be performed by one or more components of device 300, such as processors 315, storage media interface 335, channels 360A-B or the SOC 310, among other examples.

As shown in FIG. 4, process 400 may include receiving data for storage with a first cell order on a storage medium (block 410). For example, the storage device may receive data for storage with a first cell order on a storage medium, as described above.

As further shown in FIG. 4, process 400 may include encoding the data with a first encoding to generate single-encoded data (block 420). For example, the storage device may encode the data with a first encoding to generate single-encoded data, as described above.

As further shown in FIG. 4, process 400 may include encoding the single-encoded data with a second encoding to generated double-encoded data (block 430). For example, the storage device may encode the single-encoded data with a second encoding to generated double-encoded data, as described above.

As further shown in FIG. 4, process 400 may include writing the double-encoded data, having a second cell order that is lower than the first cell order, to one or more first blocks of the storage medium (block 440). For example, the storage device may write the double-encoded data, having a second cell order that is lower than the first cell order, to one or more first blocks of the storage medium, as described above.

As further shown in FIG. 4, process 400 may include reading the double-encoded data at the storage medium (block 450). For example, the storage device may read the double-encoded data at the storage medium, as described above.

As further shown in FIG. 4, process 400 may include performing decoding, associated with the second encoding, on the double-encoded data at the storage medium to generate error-corrected single-encoded data (block 460). For example, the storage device may perform decoding, associated with the second encoding, on the double-encoded data at the storage medium to generate error-corrected single-encoded data, as described above.

As further shown in FIG. 4, process 400 may include writing the error-corrected single-encoded data, having the first cell order, to one or more second blocks of the storage medium (block 470). For example, the storage device may write the error-corrected single-encoded data, having the first cell order, to one or more second blocks of the storage medium, as described above.

Process 400 may include additional implementations, such as any single implementation or any combination of implementations described below or in connection with one or more other processes described elsewhere herein.

In a first implementation, performing decoding on the double-encoded data comprises performing error correction on the double encoded data to generate the error corrected single-encoded data.

In a second implementation, alone or in combination with the first implementation, the first encoding comprises one or more of error correcting code, or low-density parity check encoding.

In a third implementation, alone or in combination with one or more of the first and second implementations, the second encoding comprises one or more of Bose–Chaudhuri–Hocquenghem (BCH) encoding, or cyclic error-correcting encoding.

In a fourth implementation, alone or in combination with one or more of the first through third implementations, the second cell order comprises single-level cell (SLC).

In a fifth implementation, alone or in combination with one or more of the first through fourth implementations, the first cell order comprises a triple-level cell (TLC) order, a quad-level cell (QLC) order, or a penta-level cell (PLC) order.

In a sixth implementation, alone or in combination with one or more of the first through fifth implementations, process 400 includes receiving a read request associated with the data, reading the double-encoded data from one or more first blocks of the storage medium, performing the decoding, associated with the second encoding, on the double-encoded data to generate the error-corrected single-encoded data, and performing decoding, associated with the first encoding, on the error corrected single-encoded data to generate decoded data.

In a seventh implementation, alone or in combination with one or more of the first through sixth implementations, performing the decoding associated with the second encoding, in connection with the read request, comprises performing the decoding associated with the second encoding at a controller of the storage device.

In an eighth implementation, alone or in combination with one or more of the first through seventh implementations, process 400 includes receiving a read request associated with the data, reading the error-corrected single-encoded data from one or more second blocks of the storage medium, and performing decoding, associated with the first encoding, on the error corrected single-encoded data to generate decoded data.

In a ninth implementation, alone or in combination with one or more of the first through eighth implementations, encoding the single-encoded data with the second encoding to generate the double-encoded data comprises using redundancy columns of the storage medium for parity bits associated with the second encoding.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems or methods described herein may be implemented in different forms of hardware, firmware, or a combination of hardware and software. The actual control hardware or software code used to implement these systems or methods is not limiting of the implementations. Thus, the operation and behavior of the systems or methods are described herein without reference to specific software code - it being understood that software and hardware can be used to implement the systems or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims or disclosed in the specification, these combinations are not intended to limit the disclosure of various implementations. In fact, many of these features may be combined in ways not specifically recited in the claims or disclosed in the specification. Although each dependent claim listed below may directly depend on only one claim, the disclosure of various implementations includes each dependent claim in combination with other claims in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein is to be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “or,” unless explicitly stated otherwise (e.g., if used in combination with “either” or “only one of”).

What is claimed is:

1. A method performed by a storage device, the method comprising:
receiving data for storage with a first cell order on a storage medium;
encoding the data with a first encoding to generate single-encoded data;
encoding the single-encoded data with a second encoding to generated double-encoded data;
writing the double-encoded data, having a second cell order that is lower than the first cell order, to one or more first blocks of the storage medium;
reading the double-encoded data at the storage medium;
performing decoding, associated with the second encoding, on the double-encoded data at the storage medium to generate error-corrected single-encoded data; and
writing the error-corrected single-encoded data, having the first cell order, to one or more second blocks of the storage medium.

2. The method of claim 1, wherein performing decoding on the double-encoded data comprises:
performing error correction on the double encoded data to generate the error corrected single-encoded data.

3. The method of claim 1, wherein the first encoding comprises one or more of:
linear error correcting code, or
low-density parity check encoding.

4. The method of claim 1, wherein the second encoding comprises one or more of
Bose–Chaudhuri–Hocquenghem (BCH) encoding, or
cyclic error-correcting encoding.

5. The method of claim 1, wherein the second cell order comprises single-level cell (SLC).

6. The method of claim 1, wherein the first cell order comprises:
a triple-level cell (TLC) order,
a quad-level cell (QLC) order, or
a penta-level cell (PLC) order.

7. The method of claim 1, comprising:
receiving a read request associated with the data;
reading the double-encoded data from one or more first blocks of the storage medium;
performing the decoding, associated with the second encoding, on the double-encoded data to generate the error-corrected single-encoded data; and
performing decoding, associated with the first encoding, on the error corrected single-encoded data to generate decoded data.

8. The method of claim 7, wherein performing the decoding associated with the second encoding, in connection with the read request, comprises:
performing the decoding associated with the second encoding at a controller of the storage device.

9. The method of claim 1, comprising:
receiving a read request associated with the data;
reading the error-corrected single-encoded data from one or more second blocks of the storage medium; and
performing decoding, associated with the first encoding, on the error corrected single-encoded data to generate decoded data.

10. The method of claim 1, wherein encoding the single-encoded data with the second encoding to generate the double-encoded data comprises:
using redundancy columns of the storage medium for parity bits associated with the second encoding.

11. A system comprising:
a controller, of a non-volatile memory device, to:
receive data for storage with a first cell order on a storage medium;
encode the data with a first encoding to generate single-encoded data;
encode the single-encoded data with a second encoding to generated double-encoded data;
write the double-encoded data, having a second cell order that is lower than the first cell order, to one or more first blocks of the storage medium;
read the double-encoded data at the storage medium;
perform decoding, associated with the second encoding, on the double-encoded data at the storage medium to generate error-corrected single-encoded data; and
write the error-corrected single-encoded data, having the first cell order, to one or more second blocks of the storage medium.

12. The system of claim 11, wherein, to perform decoding on the double-encoded data, the controller is to:
perform error correction on the double encoded data to generate the error corrected single-encoded data.

13. The system of claim 11, wherein the controller is to:
receive a read request associated with the data;
read the double-encoded data from one or more first blocks of the storage medium;
perform the decoding, associated with the second encoding, on the double-encoded data to generate the error-corrected single-encoded data; and
perform decoding, associated with the first encoding, on the error corrected single-encoded data to generate decoded data.

14. The system of claim 13, wherein, to perform the decoding associated with the second encoding, in connection with the read request, the controller is to:
perform the decoding associated with the second encoding at a controller of the storage device.

15. The system of claim 11, wherein the controller is to:
receive a read request associated with the data;
read the error-corrected single-encoded data from one or more second blocks of the storage medium; and
perform decoding, associated with the first encoding, on the error corrected single-encoded data to generate decoded data.

16. A computer program product comprising:
one or more computer readable storage media, and program instructions collectively stored on the one or more computer readable storage media, the program instructions comprising:
program instructions to receive data for storage with a first cell order on a storage medium;
program instructions to encode the data with a first encoding to generate single-encoded data;
program instructions to encode the single-encoded data with a second encoding to generated double-encoded data;
program instructions to write the double-encoded data, having a second cell order that is lower than the first cell order, to one or more first blocks of the storage medium;
program instructions to read the double-encoded data at the storage medium;
program instructions to perform decoding, associated with the second encoding, on the double-encoded data at the storage medium to generate error-corrected single-encoded data; and
program instructions to write the error-corrected single-encoded data, having the first cell order, to one or more second blocks of the storage medium.

17. The computer program product of claim 16, wherein, to perform decoding on the double-encoded data, the program instructions comprise:
program instructions to perform error correction on the double encoded data to generate the error corrected single-encoded data.

18. The computer program product of claim 16, wherein the second cell order comprises single-level cell (SLC).

19. The computer program product of claim 16, wherein the first cell order comprises:
a triple-level cell (TLC) order,
a quad-level cell (QLC) order, or
a penta-level cell (PLC) order.

20. The computer program product of claim 16, wherein, to encode the single-encoded data with the second encoding to generate the double-encoded data, the program instructions comprise:
program instructions to use redundancy columns of the storage medium for parity bits associated with the second encoding.
